(19) United States
(12) Patent Application Publication
(10) Pub. No.: US 2026/0182590 A1
(43) Pub. Date: Jul. 2, 2026

(54) IMAGING SYSTEMS AND METHODS FOR IMPROVED FOOD PROCESSING BATHS

(71) Applicant: CMS Technology, LLC, Bridgewater, NJ (US)

(72) Inventors: Mark Bramlett, Bridgewater, NJ (US); Duane Young, Bridgewater, NJ (US); Dustin Huggins, Bridgewater, NJ (US)

(73) Assignee: CMS Technology, LLC, Bridgewater, NJ (US)

(21) Appl. No.: 19/429,381

(22) Filed: Dec. 22, 2025

Related U.S. Application Data
(60) Provisional application No. 63/739,248, filed on Dec. 27, 2024.

(51) Int. Cl. A23B 2/00; G06T 7/00

(52) U.S. Cl. CPC A23B 2/003; G06T 7/001; G06T 2207/10048; G06T 2207/30128; G06T 2207/30164

(57) ABSTRACT

Provided are systems, comprising: a vessel configured to carry a working fluid and a plurality of workpieces at least partially submerged in the working fluid; an imaging device configured to obtain imaging data from a surface of the working fluid; and a controller operatively coupled to the imaging device, the controller including at least one processor and a computer-readable medium having computer-executable instructions stored thereon that, in response to execution by the at least one processor, cause the controller to perform operations including: collecting imaging data that includes the surface of the working fluid; measuring a surface profile of the surface of the working fluid; determining an amount of workpieces above the surface; and modulating one or more parameters of the system based on the amount of workpieces above the surface. Also provided are related methods of operating such systems.

### CROSS-REFERENCE(S) TO RELATED APPLICATION(S)

This application claims the benefit and priority of U.S. Provisional Application No. 63/739,248, filed on Dec. 27, 2024, the entire disclosure of which is disclosed herein in its entirety.

### FIELD OF THE DISCLOSURE

The present disclosure relates to the field of automated systems for foodstuff disinfection.

### BACKGROUND

Meats and produce can, depending on conditions, be contaminated with Salmonella, Campylobacter and/or E. coli as they are processed. To address this contamination antimicrobial interventions can be used to reduce or even eliminate bacteria on the product and in the wash water. In addition to eliminating bacteria, product quality (e.g., color, texture, retention of fat and inherent moisture) is also important to food processors.

To eliminate bacteria while ensuring superior product quality, meat and produce workpieces may be submerged into water baths for heat transfer, cleaning, and antimicrobial treatments, among other reasons. To ensure full coverage of workpieces, the water levels are traditionally controlled by visual inspection or mechanical float switches. Recent advances in technology allow users to maintain target levels with automated systems using data from pressure, radar, and ultrasonic sensors. In some instances, more water is needed above the target value due to changes in mass or increased number of workpieces. At present, however, there are scenarios that require human intervention to visually gauge and add the correct amount of water to the system to ensure full coverage of workpieces.

Accordingly, there is a long-felt need in the art for systems and methods for improved automated control of food processing baths.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the present disclosure relate to systems, comprising: a vessel configured to carry a working fluid and a plurality of workpieces at least partially submerged in the working fluid; an imaging device configured to obtain imaging data from a surface of the working fluid; and a controller operatively coupled to the imaging device, the controller including at least one processor and a computer-readable medium having computer-executable instructions stored thereon that, in response to execution by the at least one processor, cause the controller to perform operations including: collecting, with the imaging device, imaging data that includes the surface of the working fluid; measuring, from the imaging data, a surface profile of the surface of the working fluid; determining, from the surface profile, an amount of workpieces above the surface; and modulating one or more parameters of the system based on the amount of workpieces above the surface.

In an embodiment, the imaging device is an infrared camera. In an embodiment, the surface profile comprises one or more hot zones and one or more cool zones.

In an embodiment, modulating the one or more parameters of the system comprises: transmitting instructions to at least one working fluid input configured to flow working fluid into the vessel, thereby causing the at least one working fluid input to modulate a volume of working fluid in the vessel. In an embodiment, modulating the one or more parameters of the system comprises: calculating, from the surface profile, a fraction of exposed workpieces; comparing the fraction of exposed workpieces to a reference fraction of exposed workpieces; determining, from a difference between the fraction of exposed workpieces and the reference fraction of exposed workpieces, an amount of working fluid to add to the vessel through the working fluid input; and transmitting instructions to the at least one working fluid input to increase the volume of working fluid in the vessel by the amount of working fluid to add to the vessel. In an embodiment, the volume of working fluid is modulated by between about 0.1% to about 10%.

In an embodiment, modulating the one or more parameters of the system comprises: transmitting instructions to a delivery train configured to introduce workpieces into the vessel, thereby causing the delivery train to modulate a rate of operation of the delivery train. In an embodiment, modulating the rate of operation of the delivery train comprises reducing the rate at which the delivery train introduces workpieces into the vessel.

In an embodiment, modulating the one or more parameters of the system comprises: transmitting instructions to a transport train configured to transport workpieces introduced into the vessel towards an exit of the vessel, thereby causing the transport train to modulate a rate of operation of the transport train. In an embodiment, modulating the rate of operation of the transport train comprises increasing the rate at which the transport train transports workpieces towards the exit of the vessel.

In an embodiment, modulating the one or more parameters of the system comprises: transmitting instructions to a removal train configured to remove workpieces from the vessel through an exit of the vessel, thereby causing the removal train to modulate a rate of operation of the removal train. In an embodiment, modulating the rate of operation of the removal train comprises increasing the rate at which the removal train removes workpieces from the vessel.

In an embodiment, modulating the one or more parameters of the system comprises: transmitting instructions to an agitator configured to aerate the working fluid, thereby causing the agitator to modulate a level of agitation. In an embodiment, modulating the level of agitation from the agitator comprises increasing the level of agitation, thereby decreasing a density of the working fluid relative to a density of the workpieces.

In an embodiment, the system further comprises a counting sensor system configured to estimate a number of workpieces in the vessel, wherein modulating the one or more parameters of the system is further based on the number of workpieces in the vessel.

In an embodiment, the system further comprises a sensor train configured to monitor one or more conditions of the system and provide a signal based on the one or more conditions. In an embodiment, the sensor train comprises a working fluid level sensor configured to measure a level of working fluid and provide a signal based on the level of working fluid, wherein modulating the one or more parameters of the system is further based on the level of working fluid. In an embodiment, the sensor train comprises a sensor selected from the group consisting of a pH sensor configured to measure pH of the working fluid, a municipal water flow sensor configured to measure a flow of municipal water through a municipal water port, a chilled water flow sensor configured to measure a chilled water flow through a chilled water port, an antimicrobial flow sensor configured measure a flow of antimicrobial through an antimicrobial port, a rocker sensor configured to provide a status of the transport train, an unloader rate sensor configured to provide a status of the removal train, an antimicrobial reuse sensor configured to determine a level of reuse of the antimicrobial, a working fluid temperature sensor configured to determine a temperature of the working fluid, and an air agitation feature configured to deliver air agitation and also determine a pressure of air agitation delivered to the working fluid and a volume of air agitation delivered to the working fluid, or any combination thereof.

In an embodiment, the controller further causes the system to perform the operation of filtering out a tank element from the imaging data to generate a filtered imaging data, and wherein a filtered surface profile is measured from the filtered imaging data.

Also provided are methods for operating a system comprising: collecting, with an imaging device, imaging data that includes a surface of a working fluid, wherein the working fluid is carried in a vessel, and wherein a plurality of workpieces are at least partially submerged in the working fluid; measuring, from the imaging data, a surface profile of from the surface of the working fluid; determining, from the surface profile, an amount of workpieces above the surface; and modulating one or more parameters of the system based on the amount of workpieces above the surface.

In an embodiment, modulating the one or more parameters of the system comprises: transmitting instructions to at least one working fluid input configured to flow working fluid into the vessel, thereby causing the at least one working fluid input to modulate a volume of working fluid in the vessel. In an embodiment, modulating the one or more parameters of the system comprises: calculating, from the surface profile, a fraction of exposed workpieces; comparing the fraction of exposed workpieces to a reference fraction of exposed workpieces; determining, from a difference between the fraction of exposed workpieces and the reference fraction of exposed workpieces, an amount of working fluid to add to the vessel through the working fluid input; and transmitting instructions to the at least one working fluid input to increase the volume of working fluid in the vessel by the amount of working fluid to add to the vessel.

In an embodiment, modulating the one or more parameters of the system comprises: transmitting instructions to a delivery train configured to introduce workpieces into the vessel, thereby causing the delivery train to modulate a rate of operation of the delivery train. In an embodiment, modulating the one or more parameters of the system comprises: transmitting instructions to a transport train configured to transport workpieces introduced into the vessel towards an exit of the vessel, thereby causing the transport train to modulate a rate of operation of the transport train. In an embodiment, modulating the one or more parameters of the system comprises: transmitting instructions to a removal train configured to remove workpieces from the vessel through an exit of the vessel, thereby causing the removal train to modulate a rate of operation of the removal train.

In an embodiment, modulating the one or more parameters of the system comprises: transmitting instructions to an agitator configured to aerate the working fluid, thereby causing the agitator to modulate a level of agitation.

In an embodiment, the method further comprises filtering out a tank element from the imaging data to generate a filtered imaging data, and wherein a filtered surface profile is measured from the filtered imaging data. In an embodiment, the imaging device is an infrared camera.

In an embodiment, the method further comprises: counting, with a counting sensor system, a number of workpieces in the vessel; and further modulating the one or more parameters of the system based on the number of workpieces in the vessel. In an embodiment, the method further comprises: sensing, with a sensor train, one or more conditions of the system; providing a signal based on the one or more conditions of the system; and further modulating the one or more parameters of the system based on the signal.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic of a system according to an embodiment of the present disclosure;

FIG. 2 is a block diagram of a method according to an embodiment of the present disclosure;

FIG. 3A is a heat map of a surface of a vessel containing workpieces, in accordance with an embodiment of the present disclosure;

FIG. 3B is a schematic illustration of the surface depicted in FIG. 3A, in accordance with an embodiment of the present disclosure;

FIG. 4A is a heat map of a surface of a vessel containing workpieces, in accordance with an embodiment of the present disclosure; and

FIG. 4B is a schematic illustration of the surface depicted in FIG. 4A, in accordance with an embodiment of the present disclosure.

TABLE 1
Listing of Drawing elements

100 system
102 delivery train
103 workpiece
104 first counting sensor
106 removal element
108 vessel
110 transport train
112 municipal water port
114 chilled water port
116 antimicrobial port
118 removal train
120 chute
122 exit
124 second counting sensor
126 sensor train
128 working fluid
130 controller
132 first imaging device
134 second imaging device
136 exit sensor
138 source of an antimicrobial
140 air agitation feature
142 working fluid level sensor
144 working fluid temperature sensor
146 antimicrobial reuse sensor
148 unloader rate sensor
150 rocker sensor
152 antimicrobial flow sensor
154 chilled water flow sensor
156 municipal water flow sensor
158 pH sensor
160 surface imaging device
200 method
202 process block
204 process block
206 process block
208 process block
210 process block
212 process block
310 hot zone
320 cool zone
410 warm zone
420 cool zone

### DETAILED DESCRIPTION

In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

In certain embodiments, the systems and methods of the present disclosure include modulating one or more parameters of a treatment vessel, including but not limited to a treatment vessel configured to carry a process fluid including an antimicrobial, where said treatment vessel is configured to carry a process fluid for treating workpieces. In certain embodiments, modulating one or more parameters of the treatment vessel is performed autonomously and without human intervention. As discussed further herein, modulating the one or more parameters of the treatment vessel may be suitable to improve coverage of workpieces and prevent workpieces from being exposed through a surface of the process fluid (also referred to herein as “working fluid”). Parameters to be modulated include a fluid level, a rate of introducing workpieces to the system, a rate of removing workpieces from the system, and a rate of agitation of the process fluid of the system. Without such a modulation of parameters, a workpiece might exit the vessel having received insufficient contact with the process fluid to be properly treated such that, for example, a workpiece bacterial load exceeds important treatment criteria and milestones.

The present disclosure may be understood more readily by reference to the following detailed description of desired embodiments and the examples included therein.

Aspects of the present disclosure relate to systems, comprising: a vessel configured to carry a working fluid and a plurality of workpieces at least partially submerged in the working fluid; an imaging device configured to obtain imaging data from a surface of the working fluid; and a controller operatively coupled to the imaging device, the controller including at least one processor and a computer-readable medium having computer-executable instructions stored thereon that, in response to execution by the at least one processor, cause the controller to perform operations including: collecting, with the imaging device, imaging data that includes the surface of the working fluid; measuring, from the imaging data, a surface profile of the surface of the working fluid; determining, from the surface profile, an amount of workpieces above the surface; and modulating one or more parameters of the system based on the amount of workpieces above the surface. In some embodiments, the controller performs operations autonomously.

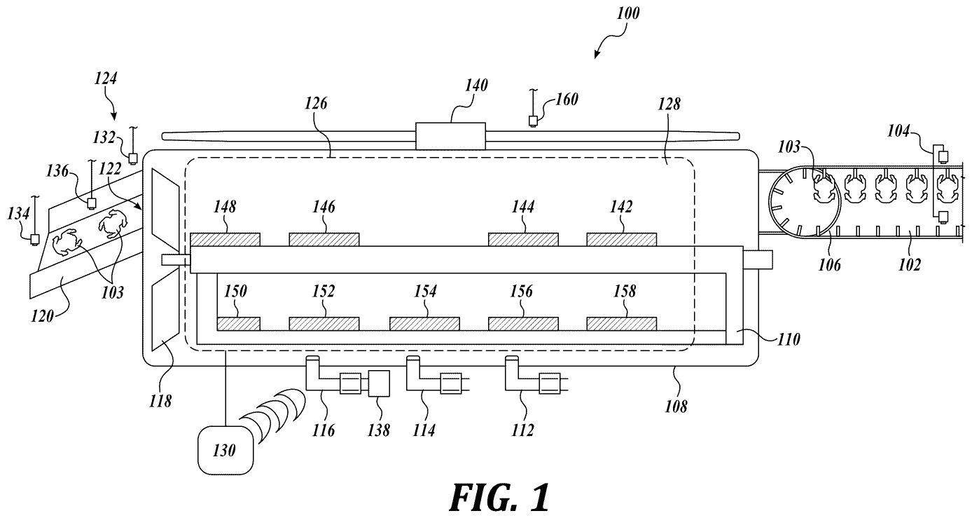

In this regard, a system 100, in accordance with an embodiment of the present disclosure, will now be described with respect to FIG. 1. As shown, the system 100 includes a delivery train 102 configured to deliver or introduce a workpiece 103 to a vessel 108. A workpiece 103 can be, e.g., a whole animal, an animal part, a piece of fruit, a part of a piece of fruit, a vegetable, a piece of a vegetable, and the like. While certain Examples and embodiments of the present disclosure describe poultry carcasses, and, in certain embodiments, chicken carcasses, it will be understood that the systems and methods of the present disclosure are suitable for and configured to process other workpieces 103. In an embodiment, delivery train 102 comprises, e.g., shackles, hooks, paddles, augers, and the like, configured to deliver or introduce workpieces 103 into the vessel 108.

In the illustrated embodiment, system 100 is shown to include a removal element 106 configured to remove workpieces 103 from delivery train 102 and encourage the removed workpieces 103 into vessel 108 of the system 100. As shown, system 100 also includes a first counting sensor 104 (e.g., an optical sensor, such as one utilizing one of visible light, ultraviolet light, infrared light, and the like) that is configured to detect a workpiece 103 delivered to vessel 108.

In an embodiment, the first counting sensor 104 is configured to generate an entrance signal based upon a workpiece 103 introduced into the vessel 108. In this regard, the first counting sensor 104 can, thus, be used and/or configured to count the number of workpieces 103, including but not limited to by generating an entrance signal based upon a workpiece 103 introduced into the vessel 108, that are delivered as a function of time (e.g., 50 chickens in 60 minutes), thereby allowing a user (and the system 100) to monitor the influx of workpieces 103 into the system 100.

In an embodiment, first counting sensor 104 is configured to count workpieces 103 that are not delivered to the system 100, e.g., a workpiece 103 that is not removed from delivery train 102 and/or a workpiece 103 that is rejected at the location of the vessel 108 entrance.

In an embodiment, the vessel 108 is, e.g., a tank, including but not limited to a semicylindrical tank. Other tank shapes (e.g., squared-off or rectangular) are also within the scope of the present disclosure.

In an embodiment, the tank is open at the top, but this is not a requirement, as a tank can be enclosed (e.g., a cylindrical tank) and/or can include a lid that at least partially encloses the contents of the tank. In the illustrated embodiment, the vessel 108 includes a transport train 110 (e.g., a paddle or rocker) that encourages workpieces 103 delivered to vessel 108 toward an exit 122 of vessel 108. In some embodiments, vessel 108 can itself rock back and forth or otherwise oscillate to encourage the movement of workpieces 103 within the vessel 108.

In an embodiment, the vessel 108 can receive fluid from exterior to the vessel 108. As shown, vessel 108 is configured to receive fluid from a number of fluid sources. In the illustrated embodiment, the vessel 108 is configured to receive city or municipal water from a municipal water port 112 and/or chilled water port 114, respectively.

As shown, the system 100 includes a municipal water port 112 configured to place the vessel 108 in fluid communication with a municipal water source (not shown). Likewise, the system 100 is shown to include a chilled water port 114 configured to place the vessel 108 in fluid communication with a chilled water source (not shown). In this regard, the vessel 108 is configured to receive chilled and municipal water, such as to make up portions of the working fluid 128. Multiple fluid sources may advantageously provide additional control over a temperature of fluid introduced as make up portions of the working fluid 128. There may also be cost advantages to the use of multiple fluid sources, such as due to the lower cost of providing municipal water to the vessel 108 relative to providing treated water such as chilled water.

Further, the system 100 is shown to include an antimicrobial port 116 configured to place the vessel 108 in fluid communication with a source of an antimicrobial 138. In this regard, the vessel 108 is configured to receive an antimicrobial, which microbial can be a peroxyacid, including but not limited to peracetic acid (PAA).

The flow rate through any one or more of municipal water port 112, chilled water port 114, and antimicrobial port 116 into vessel 108 can be modulated in a manual fashion (e.g., by a user) and/or in an automated and/or autonomous fashion (e.g., by the system 100 itself), such as discussed further herein.

The working fluid 128 (within vessel 108) can comprise the antimicrobial along with water (chilled or otherwise). The working fluid 128 can, of course, include components in addition to the antimicrobial and water, including but not limited to those configured to adjust a pH of the working fluid 128.

As shown, the system 100 includes an air agitation feature 140, which air agitation feature 140 can be used to agitate the working fluid 128. Without being bound to any particular theory or embodiment, the agitation can act to prevent a thermal layer in the working fluid 128 or air within the vessel 108. Under certain circumstances, workpieces 103 delivered to vessel 108 could, without further intervention, accumulate at the top (or bottom) of vessel 108.

By application of air agitation, including but not limited to with air agitation feature 140, workpieces 103 can be moved about within the working fluid 128, thereby more uniformly distributing them within the working fluid 128, which in turn gives rise to the workpieces 103 being more uniformly exposed to the working fluid 128.

Also, without being bound to any particular theory or embodiment, the applied agitation can assist with massaging the working fluid 128 into the workpieces 103 themselves. This may be advantageous in circumstances where the workpiece includes difficult to access regions, such as in the example of whole birds, where a wing flap may partially block fluid from contacting a portion of the body of the whole bird when the wing is pressed against the body because the agitation will improve penetration of the working fluid 128 into the workpiece 103.

Also as shown in FIG. 1, system 100 includes a removal train 118 configured to encourage workpieces 103 from vessel 108, such as through an exit 122 of the vessel 108. In an embodiment, the removal train 118 is, e.g., a bladed or flighted component that extracts workpieces 103 from vessel 108, e.g., in the manner of an Archimedes-type screw pump. In an embodiment, the removal train 118 includes a component similarly shaped to a bladed fan configured to encourage workpieces from vessel 108. In an embodiment, the removal train 118 also includes a conveyor, a shackle line, and the like.

When removed, a workpiece 103 can be counted or otherwise analyzed by second counting sensor 124, which second counting sensor 124 can be configured to count the number of workpieces 103 that are removed as a function of time from vessel 108. In an embodiment, the second counting sensor 124 is configured to generate an exit signal based upon a workpiece 103 removed from the vessel 108 through the exit 122.

In this way, the count of workpieces 103 entering vessel 108, such as counted by the first counting sensor 104, and the count of workpieces 103 leaving vessel 108, such as counted by the second counting sensor 124, can be used to determine a net accumulation (or a net reduction) of workpieces 103 within vessel 108 over time. For instance, if the count of workpieces 103 entering vessel 108 as determined by the first counting sensor 104 is greater than the count of workpieces 103 leaving vessel 108 as determined by the second counting sensor 124 over a set time period, then there has been a net accumulation of workpieces 103 within the vessel.

As shown in FIG. 1, the system 100 includes a sensor train 126 (illustrated as within the dashed line in FIG. 1) configured to monitor one or more conditions of the system 100 and provide one or more signals related to or based on the condition. In an embodiment, the sensor train 126 is configured to monitor one or more conditions of the system 100 and provide one or more signals based on the one or more conditions. In an embodiment, sensor train 126 is configured to monitor one or more of a number of conditions of the system 100.

In the illustrated embodiment, the sensor train 126 includes a pH sensor 158 configured to measure pH of working fluid 128, a municipal water flow sensor 156 configured to measure flow of municipal water (e.g., in L) through the municipal water port 112, a chilled water flow sensor 154 configured to measure chilled water flow (e.g., in L) through the chilled water port 114, an antimicrobial flow sensor 152 configured measure flow of antimicrobial (e.g., in L) through the antimicrobial port 116, a rocker sensor 150 configured to provide a status of the transport train 110, an unloader rate sensor 148 configured to provide a status of removal train 118, an antimicrobial reuse sensor 146 configured to determine a level of reuse of antimicrobial (e.g., in L), a working fluid temperature sensor 144 configured to determine a temperature (e.g., in degrees Celsius) of the working fluid 128, a working fluid level sensor 142 configured to measure a level of working fluid 128 (e.g., in cm), an air agitation feature 140 configured to deliver air agitation and also determine a pressure (e.g., in PSI) of air agitation delivered to the working fluid 128 and a volume (e.g., in L) of air agitation delivered to working fluid 128, and the like.

The sensor train 126 can also be configured to detect one or more of: a fat content of a workpiece 103, a fat content of the working fluid 128, an organic load of a workpiece 103, an organic load of the working fluid 128, an amount of an organic material in the working fluid 128, a turbidity of the working fluid 128, an amount of the antimicrobial in the working fluid 128, a bacteria count of a workpiece 103, a bacteria count of the working fluid 128, a moisture content of a workpiece 103, a flow of water out of the vessel 108, a flow of working fluid 128 out of the vessel 108.

As described elsewhere herein, any one or more of the foregoing can be used as a basis for modulating an operating condition of the system 100.

As shown in FIG. 1, the system 100 includes a surface imaging device 160 configured to obtain imaging data from a surface of the working fluid 128, and provide one or more signals related to or based on the surface of the working fluid 128. In an embodiment, surface imaging device 160 collects imaging data including the surface of the working fluid 128. In an embodiment, the imaging data is photographic imaging data. In an embodiment, the imaging device is an infrared camera, and the imaging data is an infrared image of the surface of the working fluid 128. In an embodiment, the imaging device is a depth camera.

In an embodiment, surface imaging device 160 includes two or more imaging devices, including but not limited to two or more cameras. In an embodiment, the two or more imaging devices can be substantially identical imaging devices. In an embodiment, the two or more imaging devices can be different types of imaging devices, including but not limited to where one imaging device is a photographic imaging camera (i.e., a visible light camera) and a second imaging device is an infrared camera. Without wishing to be bound by any particular theory, different types of imaging devices May advantageously provide complementary information, such as where a photographic imaging camera may provide information related to features with similar temperatures but different colors, while an infrared camera may provide information related to differences in temperature between elements that are visually similar and/or difficult to distinguish in appearance.

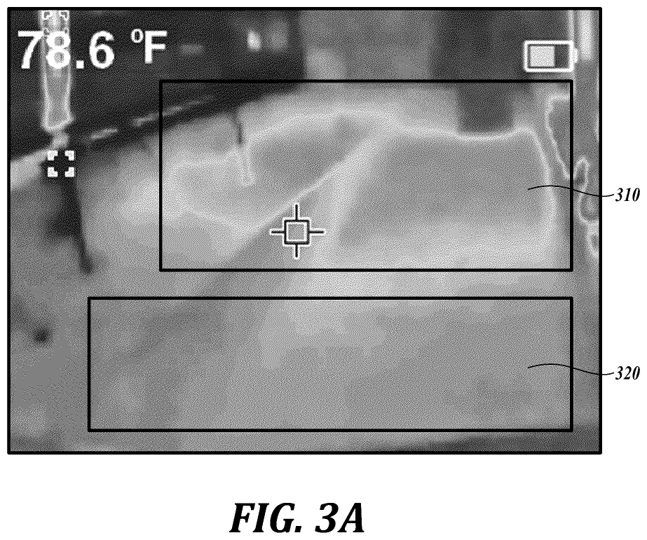

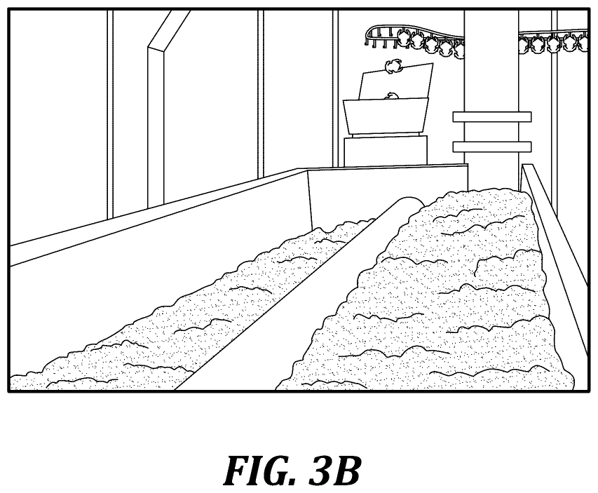

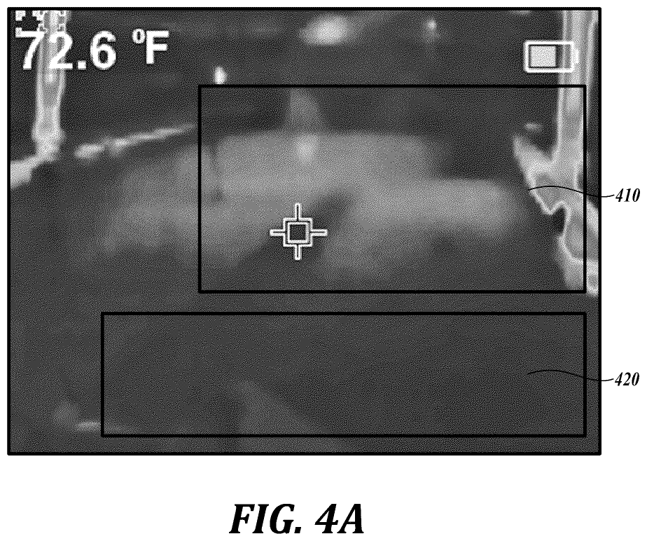

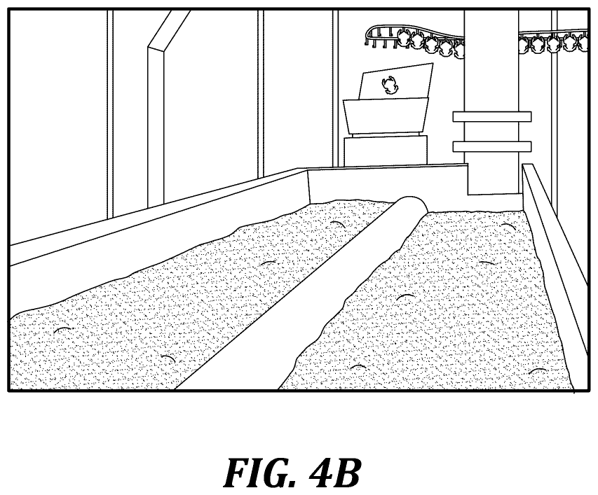

In this regard, the surface imaging device 160 is configured to obtain imaging data from the surface of working fluid 128, as is described further herein and with respect to FIG. 3A-FIG. 4B.

In an embodiment, the temperature of a workpiece when it enters the vessel is about 120° F., 110° F., 100° F., 90° F., 80° F., or 70° F. In an embodiment, the temperature of a workpiece when it enters the vessel is between about 70° F. and about 120° F., between about 80° F. and about 120° F., between about 90° F. and about 120° F., or between about 100° F. and about 120° F.

In an embodiment, the temperature of a workpiece when it enters the vessel is greater than about 90° F. In an embodiment, a workpiece is in the vessel for about 20 minutes, 25 minutes, 30 minutes, 35 minutes, or 40 minutes.

In an embodiment, when a workpiece exits the vessel, the temperature of the workpiece is about 80° F., 70° F., 60° F., 50° F., or 40° F. In an embodiment, the temperature of a workpiece when it exits the vessel is between about 40° F. and about 80° F., between about 40° F. and about 70° F., between about 40° F. and about 60° F., or between about 40° F. and about 50° F.

In an embodiment, the temperature of a workpiece when it exits the vessel is less than about 40° F. In an embodiment, the temperature of the workpieces proximate the entrance to the vessel is larger in magnitude than the temperature of the workpieces proximate the exit to the vessel.

In the illustrated embodiment, the system 100 is shown to include a controller 130. As described further herein, the controller 130 is operatively coupled to various system 100 components, such as to exchange signals therebetween and to choreograph their operation. While a single controller 130 is illustrated in and described with respect to FIG. 1, it will be understood that the controller 130 can include one or multiple processors and/or can be part of a distributed system. In this regard, the controller 130 can be physically part of and/or coupled to the system 100. Likewise, in an embodiment, the controller 130 is not part of or coupled to the system 100 and is, in this embodiment, physically remote from the system 100, but nevertheless operatively coupled to one or more components of the system 100. In some embodiments, the controller is configured to autonomously exchange signals between various system 100 components and to choreograph the operation of various system 100 components.

In an embodiment, the controller 130 is operatively coupled to the first counting sensor 104, the second counting sensor 124, the sensor train 126, and the surface imaging device 160, such as to exchange signals therebetween. As shown, the controller 130 is in electronic (and/or radio or other wireless) communication with the first counting sensor 104, the second counting sensor 124, the sensor train 126, and the surface imaging device 160. In an embodiment, the controller 130 can be configured to, in response to one or more signals of sensor train 126, modulate one or more parameters of system 100. In an embodiment, the controller 130 can be configured to, in response to one or more signals of surface imaging device 160, modulate one or more parameters of the system. Various logic modules of the controller 130 may be implemented in software/firmware executed on a general-purpose microprocessor, in hardware (e.g., application specific integrated circuit), or a combination of both.

In an embodiment, the controller 130 includes at least one processor and a computer-readable medium having computer-executable instructions stored thereon that, in response to execution by the at least one processor, cause the controller to perform operations including counting, with first counting sensor 104, a number of workpieces 103 entering the vessel 108 based on the entrance signal; counting, with the second counting sensor 124, a number of workpieces 103 exiting the vessel 108 based on the exit signal.

As above, in an embodiment, the controller 130 is operatively coupled to the first counting sensor 104 and the second counting sensor 124. As also described further herein, in an embodiment, the controller 130 includes at least one processor and a computer-readable medium having computer-executable instructions stored thereon that, in response to execution by the at least one processor, cause the controller to perform operations including counting, with first counting sensor 104, a number of workpieces 103 entering the vessel 108, such as based on the entrance signal; and counting, with the second counting sensor 124, a number of workpieces 103 exiting the vessel 108, such as based on the exit signal.

In an embodiment, the system 100 is configured to count a number of workpieces 103 entering and/or exiting portions of the system 100, including but not limited to the vessel 108, through image processing including so-called blob analysis.

Accordingly, in an embodiment, the controller 130 includes circuitry to define signals generated by imaging devices of the counting sensors, including but not limited to first counting sensors 104 and 124 as corresponding to portions of a scene either including or not including a workpiece 103, including but not limited to through binarization of the image and setting a greyscale threshold to define each pixel as black (i.e., corresponding to a portion of the image not containing a workpiece 103) or white (i.e., corresponding to a portion of the image containing a workpiece 103).

In this regard, still referring to FIG. 1, the second counting sensor 124 includes a first imaging device 132 positioned to image the exit 122, wherein the exit signal comprises signal from a plurality of pixels of the first imaging device 132, and wherein counting, with the second counting sensor 124, a number of workpieces 103 exiting the vessel 108 based on the exit signal comprises defining signal from pixels of the plurality of pixels as either empty signal corresponding to a portion of the exit 122 not including a workpiece 103 or workpiece signal corresponding to a portion of the exit 122 including a workpiece 103 based on a greyscale threshold; summing an area of the exit 122 occupied by workpieces 103 based on the workpiece signal; and dividing the area of the exit 122 occupied by workpieces 103 by an average workpiece 103 area to provide an average workpiece 103 number.

In an embodiment, the system 100 is configured to perform line scan imaging. Accordingly, still referring to FIG. 1, the second counting sensor 124 is shown comprise an exit sensor 136 configured to generate a batch signal when a last workpiece 103 of the number of workpieces 103 exits the exit 122; and a chute sensor configured to generate a chute exit signal when a workpiece 103 exits a chute 120 positioned to receive workpieces 103 from the exit 122; wherein the first imaging device 132 is a line scan camera positioned to image workpieces 103 on the chute 120. In an embodiment, the controller 130 includes at least one processor and a computer-readable medium having computer-executable instructions stored thereon that, in response to execution by the at least one processor, cause the controller to perform operations including generating, with the line scan camera, a plurality of line scan images starting upon receipt of the chute exit signal and ending upon receipt of the batch signal; and compiling the plurality of line scan images to provide the exit signal.

Still referring to FIG. 1, in an embodiment, the first imaging device 132 is positioned to image the exit 122 and a chute 120 positioned to receive workpieces 103 from the exit 122, and wherein the second counting sensor 124 further comprises second imaging device 134 positioned to image a chute 120 exit. In such an embodiment, the controller 130 may further include at least one processor and a computer-readable medium having computer-executable instructions stored thereon that, in response to execution by the at least one processor, cause the controller to perform operations including generating a first image, with the first imaging device 132, of workpieces 103 in the chute 120; and generating a second image, with the second imaging device 134, of workpieces 103 in the chute 120 exit; and combining the first image and the second image to provide a combined image. Counting, with the second counting sensor 124, a number of workpieces 103 exiting the vessel 108 is based on the exit signal comprises counting a number workpieces 103 in the combined image.

In an embodiment, such counts of workpieces 103 entering and exiting the vessel 108 can be used to determine a number of workpieces 103 present in the vessel 108 as a function of time. Accordingly, in an embodiment, the controller 130 includes at least one processor and a computer-readable medium having computer-executable instructions stored thereon that, in response to execution by the at least one processor, cause the controller to perform operations including calculating a dwell time or density of workpieces 103 in the vessel 108, including but not limited to based on a number of workpieces 103 present in the vessel 108 as a function of time.

In an embodiment, the dwell time is based on an average or a measured time a workpiece 103 is in the vessel 108. As used herein, a dwell time refers to a time, including but not limited to an average or measured time, a workpiece 103 is in the vessel 108. As an example, a system 100 can derive dwell time based on number of products in the vessel 108 divided by the speed at which they are removed until empty, e.g., 1000 products/100 products removed per minute=dwell time of 10 minutes.

Such a dwell time is in contrast to and distinct from a workload of the system 100 as a whole, which may be determined by a number of workpieces 103 entering the system 100 and exiting the system 100 in a given time. In this regard, a dwell time refers to a time, whether average or measured, that a workpiece 103 is in the vessel 108, including but not limited to in the working fluid 128 of the vessel 108, whereas a workload merely refers to a number of workpieces 103 processed by a system 100 without providing information as to time a workpiece 103 spent in a treatment vessel 108.

In an embodiment, the workpiece 103 density is based on an average or a measured number of workpieces 103 in the vessel 108 and a volume of the working fluid 128, such as may be altered over a period of time. In the case of poultry and a chiller application, the system 100 can measure the incoming and outgoing load and calculate a bird density (within the system 100) based on the size of the chiller and/or volume of the working fluid 128 disposed in the vessel 108. Other performance parameters can also be adjusted to optimize both antimicrobial and product quality performance for the workpiece 103 density.

In an embodiment, the controller 130 includes at least one processor and a computer-readable medium having computer-executable instructions stored thereon that, in response to execution by the at least one processor, cause the controller to perform operations including modulating the one or more conditions of the system 100 based on the dwell time or density of workpieces 103 in the vessel 108. In an embodiment, the controller 130 includes at least one processor and a computer-readable medium having computer-executable instructions stored thereon that, in response to execution by the at least one processor, cause the controller to perform operations including modulating the one or more parameters of the system 100, including but not limited to modulating the level of working fluid 128 in the vessel 108, based on the dwell time or density of workpieces 103 in the vessel 108. By adjusting the inflow and outflow of workpieces 103, the system 100 can ensure that workpieces 103 within the system 100 experience a suitable dwell time, which dwell time allows for the workpieces 103 to meet any temperature regulations (e.g., a bird must attain a temperature of 40 degrees within 4 hours of the bird's killing) as well as for the workpieces 103 to meet other criteria, including but not limited to bacterial load.

As discussed further herein, the controller 130 includes at least one processor and a computer-readable medium having computer-executable instructions stored thereon that, in response to execution by the at least one processor, cause the controller to perform operations including modulating the one or more conditions of the system 100, including but not limited to based on the dwell time or density of workpieces 103 in the vessel 108. A non-exhaustive listing of the one or more conditions of the system 100 includes, inter alia, a rate of workpiece 103 delivery to the vessel 108, a rate of workpiece 103 exit from the vessel 108, a temperature of the working fluid 128 within the vessel 108, a temperature of a workpiece 103, a volume of the working fluid 128 within the vessel 108, a depth of the working fluid 128 within the vessel 108, a pH of the working fluid 128 within the vessel 108, a flow of water into the vessel 108, a number of workpieces 103 within the vessel 108, a fat content of a workpiece 103, a fat content of the working fluid 128, an organic load of a workpiece 103, an organic load of the working fluid 128, an amount of an organic material in the working fluid 128, a turbidity of the working fluid 128, an amount of the antimicrobial in the working fluid 128, a bacteria count of a workpiece 103, a bacteria count of the working fluid 128, a moisture content of a workpiece 103, a flow of water out of the vessel 108, a flow of working fluid 128 out of the vessel 108, and any combination thereof.

In an embodiment, modulating the one or more conditions of the system 100 is selected from one or more of (1) modulating operation of the delivery train 102, (2) modulating operation of the transport train 110, (3) modulating operation of the removal train 118, (4) modulating an amount of the working fluid 128 within the vessel 108, (5) modulating a flow of chilled water to the vessel 108, (6) modulating a flow of municipal water to the vessel 108, (7) modulating a flow of an antimicrobial to the vessel 108 (8) modulating a temperature of the working fluid 128 within the vessel 108, and (9) modulating a pH of the working fluid 128 within the vessel 108.

Still referring to FIG. 1, in an embodiment the system 100 is configured to image the surface of working fluid 128 in vessel 108, and to identify the presence of exposed workpieces 103. Accordingly, in an embodiment, the controller 130 includes circuitry to define signals generated by an imaging device, such as is generated by surface imaging device 160, as corresponding to portions of the surface of working fluid 128 with exposed workpieces, including but not limited to through obtaining thermal imaging data and assigning a temperature value to each pixel, thus identifying warm regions (i.e., corresponding to exposed workpieces 103) or cool regions (i.e., corresponding to submerged workpieces 103). Without being bound by theory, workpieces 103 may become exposed (i.e., not covered by working fluid 128) due to the number of workpieces 103 being too high relative to the volume of working fluid 128, due to variability in the volume of individual workpieces 103, or due to inconsistencies in the shape and packing of workpieces 103 in the vessel 108. For example, in some time periods, the average size of a workpiece 103 may be larger than at a subsequent or different time period, such that a set point of the amount of working fluid 128 in the vessel 108 may be inadequate for the total volume of workpieces 103.

In an embodiment, the controller 130 modulates one or more parameters of the system 100. In an embodiment, modulating the one or more parameters of the system 100 comprises (1) transmitting instructions to at least one working fluid input, including but not limited to municipal water port 112, chilled water port 114, and antimicrobial port 116, configured to flow working fluid 128 into the vessel 108, thereby causing the at least one working fluid input to modulate the volume of working fluid 128 in the vessel 108; (2) transmitting instructions to delivery train 102 configured to introduce workpiece 103 into the vessel 108, thereby causing the delivery train 102 to modulate a rate of operation of the delivery train 102; (3) transmitting instructions to transport train 110 configured to transport workpiece 103 introduced into the vessel 108 towards an exit 122 of the vessel 108, thereby causing the transport train 110 to modulate a rate of operation of the transport train 110; (4) transmitting instructions to removal train 118 configured to remove workpiece 103 from the vessel 108 through an exit 122 of the vessel 108, thereby causing the removal train 118 to modulate a rate of operation of the removal train 118; and (5) transmitting instructions to an agitator, including but not limited to air agitation feature 140, configured to aerate the working fluid 128, thereby causing the agitator to modulate a level of agitation.

In an embodiment, modulating the one or more parameters of the system 100 comprises: calculating, from the surface profile, a fraction of exposed workpiece 103; comparing the fraction of exposed workpieces 103 to a reference fraction of exposed workpieces 103; determining, from the difference between the fraction of exposed workpieces 103 and the reference fraction of exposed workpieces 103, an amount of working fluid 128 to add to the vessel 108, if any, through the working fluid input, including but not limited to through municipal water port 112, chilled water port 114, and antimicrobial port 116; and transmitting instructions to the at least one working fluid input to increase the volume of working fluid 128 in the vessel 108 by the amount of working fluid 128 to add to the vessel 108.

In an embodiment, the volume of working fluid 128 is modulated by between about 0.05% to about 20%, by between about 0.1% to about 10%, by between about 0.5% to about 10%, by between about 1% to about 10%, by between about 2% to about 9%, by between about 3% to about 8%, by between about 4% to about 7% or by between about 5% to about 6%.

In an embodiment, the system 100 is configured to modulate working fluid 128 level in the vessel 108 based on measured or average workpiece 103 dwell time or density, including but not limited to when the workpiece 103 dwell time or density is outside of a predetermined range. The level of working fluid 128 can be adjusted further for performance and water conservation.

In an embodiment, modulating the one or more parameters of the system 100 comprises: transmitting instructions to a delivery train 102 configured to introduce workpieces 103 into the vessel 108, thereby causing the delivery train 102 to modulate a rate of operation of the delivery train 102. Modulating the rate of operation of the delivery train 102 can include reducing the rate at which the delivery train 102 introduces workpiece 103 into the vessel 108. By reducing the rate at which delivery train 102 introduces workpiece 103 in the vessel 108, a smaller relative number of workpieces 103 can be introduced into the system, thus decreasing crowding and resulting in a greater fraction of submerged workpieces 103.

In an embodiment, modulating the one or more parameters of the system 100 comprises: transmitting instructions to a transport train 110 configured to transport workpieces 103 introduced into the vessel 108 towards an exit 122 of the vessel 108, thereby causing the transport train 110 to modulate a rate of operation of the transport train 110. Modulating the rate of operation of the transport train 110 can include increasing the rate at which the transport train 110 transports workpieces 103 towards the exit 122 of the vessel 108. By increasing the rate at which transport train 110 transports workpieces 103 towards the exit 122 of the vessel 108, local inconsistencies in packing volume of the workpiece 103 can be more quickly resolved, including but not limited to by moving a relatively dense region of workpieces 103 into a region that is relatively sparse with respect to workpieces 103.

In an embodiment, modulating the one or more parameters of the system 100 comprises: transmitting instructions to a removal train 118 configured to remove workpieces 103 from the vessel 108 through an exit 122 of the vessel 108, thereby causing the removal train 118 to modulate a rate of operation of the removal train 118. Modulating the rate of operation of the removal train 118 can include increasing the rate at which the removal train 118 removes workpieces 103 from the vessel 108. By increasing the rate at which the removal train 118 removes workpieces 103 from the vessel 108, a larger number of workpieces 103 can be removed relative to the total number of workpieces 103 in the vessel 108, thus resulting in a smaller relative number of workpieces 103 maintained in the system 100. This can decrease crowding and result in a greater fraction of submerged workpieces 103 or no unsubmerged workpieces 103.

The system 100 can also monitor the operation of the removal or unloader train 118, including but not limited to with the second counting sensor 124. As explained elsewhere herein, unloader rate alone or in combination with the rate of incoming product can be used to modulate workpiece 103 dwell time and/or workpiece 103 density. For example, if the rate of outgoing workpieces 103 greatly exceeds the rate of incoming workpieces 103, the outgoing workpieces 103 may not have experienced a sufficient dwell time in the working fluid 128. As a result, the system 100 can reduce the rate at which workpieces 103 are removed from the vessel 108, which reduced removal rate in turn gives rise to a longer dwell time. Likewise, if the rate of incoming product greatly exceeds the rate of outgoing product, the workpiece 103 density may exceed a predetermined level or range. In this regard, in an embodiment, the system 100 is configured to modulate a rate at which workpieces 103 are introduced that more closely matches the rate at which workpieces 103 exit the vessel 108, including but not limited to with the delivery train 102, to provide a lower workpiece 103 density.

In an embodiment, modulating the one or more parameters of the system 100 comprises: transmitting instructions to an agitator, including but not limited to air agitation feature 140, configured to aerate the working fluid, thereby causing the agitator to modulate a level of agitation. Modulating the level of agitation from the agitator can include increasing the level of agitation, thereby decreasing a density of the working fluid relative to a density of the workpieces. Modulating the level of agitation from the agitator can also result in increased mixing, thus encouraging floating workpieces 103 to become submerged in working fluid 128.

In an embodiment, modulating the one or more parameters of the system 100 comprises modulating the one or more parameters in part based on the number of workpieces 103 in the system, such as is described with respect to first counting sensor 104 and second counting sensor 124, herein above. In this manner, the number of workpieces 103 can be factored into determining how modulation of the one or more parameters of the system 100 should proceed. For example, when the number of workpieces 103 is relatively low but the surface profile indicates a large amount of exposed workpieces 103, there may be a large fraction of floating workpieces 103, which could be resolved by operating the agitator as described herein above. Similarly, if the number of workpieces 103 is relatively high and the surface profile indicates a large amount of exposed workpieces 103, one or more parameters may be adjusted, including but not limited to by decreasing the rate of operation of the delivery train 102 and increasing the volume of working fluid 128.

While the above interaction between the data obtained by the surface imaging device 160 and the first counting sensor 104 and second counting sensor 124 is highlighted, it is to be understood that information obtained from the surface imaging device 160 can also be combined with any of the data provided by the sensor train 126 to determine how to modulate the one or more parameters of the system 100.

A non-limiting discussion of the modulation of other system 100 conditions not directly related to process water level adjustments based on the amount of exposed workpieces will now be described.

### Make-Up Water.

In an embodiment, the system 100 is configured to modulate the inflow of make-up water, where such make-up water is introduced at an appropriate temperature (such as at the temperature of the working fluid 128) and with an appropriate control of other parameters. For instance, during processing, water can become saturated with organic material. There thus exists a need to remove at least some processing water and add additional water (city or chilled) to reduce the organic material in the processing water. Determining and controlling levels of organic material has bearing on pathogen reduction and product quality and can also improve water conservation.

In an embodiment, the system 100 is configured to modulate inflow of make-up water when a workpiece 103 dwell time or density is outside of a predetermined range.

Temperature and/or pH.

In an embodiment, the one or more conditions of the system 100 comprises a temperature of the working fluid 128 of the system 100 or a pH of the working fluid 128 of the system 100. In an embodiment, the system 100 is configured to modulate temperature and/or pH, as these variables can influence antimicrobial performance and product quality. In an embodiment, the system 100 is configured to modulate the temperature and/or pH of the working fluid 128 when the workpiece 103 dwell time or density is outside of a predetermined level.

Accordingly, in an embodiment, the controller 130 further includes at least one processor and a computer-readable medium having computer-executable instructions stored thereon that, in response to execution by the at least one processor, cause the controller to perform operations including modulating one or more operations of the system 100 when the temperature of the working fluid 128 lies outside a predetermined range.

Likewise, in an embodiment, the controller 130 further includes at least one processor and a computer-readable medium having computer-executable instructions stored thereon that, in response to execution by the at least one processor, cause the controller to perform operations including modulating one or more operations of the system 100 when the pH of the working fluid 128 lies outside a predetermined range. pH can be measured and adjusted, as needed, by addition of a pH control agent and/or incoming water source. The water temperature can also be measured and linked to water dumping/overflow and dosing with either city or chilled water to maintain a target temperature.

In an embodiment, the system 100 can be configured to modulate the flow of antimicrobial, city water, and/or chilled water to achieve a desired temperature.

### Agitation.

In an embodiment, the system 100 is configured to modulate a degree of agitation, as well as the type of agitation that is provided within the system 100, including but not limited to with air agitation feature 140.

Agitation can be modulated and adjusted to achieve antimicrobial performance and product quality. As but one example, if workpieces 103 (also termed “product”) leaving the vessel 108 are found to exhibit microbial loads that are higher than desired, a system 100 can increase the level of agitation within the system 100 to effect more vigorous application of the antimicrobial working fluid 128 to the workpieces 103 in the system 100, which more vigorous application can in turn give rise to increased antimicrobial performance within the working fluid 128.

Additionally, if workpiece 103 dwell time or density are outside of a predetermined range, the system 100 may be configured to increase or decrease an amount or type of agitation applied to the working fluid 128.

### Antimicrobial

In an embodiment, the system 100 is configured to modulate the concentration of the antimicrobial in the working fluid 128, where antimicrobial concentration can be measured via a sensor or proportional flow control at the application point. Adjustments with incoming water or antimicrobial can also be made to optimize performance based on other measured parameters (product density, temperature, organic load, turbidity, and the like).

As discussed further herein, in an embodiment, the system 100 includes a source of an antimicrobial 138 in fluid communication with the interior of the vessel 108, including but not limited to through antimicrobial port 116. In an additional embodiment, the controller 130 further includes at least one processor and a computer-readable medium having computer-executable instructions stored thereon that, in response to execution by the at least one processor, cause the controller to perform operations including modulating flow of the antimicrobial into the vessel 108 based on the dwell time or density of workpieces 103 in the vessel 108.

In this regard, as workpiece 103 density, for example, exceeds a predetermined range, the system 100 may be configured to increase a concentration of antimicrobial in order to compensate for an otherwise higher than acceptable workpiece 103 density. Likewise, in an embodiment, when workpiece 103 dwell time falls below a predetermined range or level, an amount of antimicrobial can be added to the working fluid 128 to compensate for an otherwise lower than acceptable workpiece 103 dwell time.

Turbidity and/or Oxygen Content.

As described elsewhere herein, the turbidity and/or oxygen content of the working fluid 128 can be monitored. Without being bound to any particular theory, these can be indicative of organic load. If one or more of these measurements exceeds a threshold level, the system 100 can in response dump excess water and add make-up water to reduce the turbidity and/or oxygen content of the working fluid 128.

### Fluid Re-Use.

In an embodiment, the system 100 is configured to capture and reuse working fluid 128 upstream in the process. This working fluid 128 can be taken from the application point and directed upstream or the application point could be the recipient of the reused water. In both cases, the system 100 can adjust control parameters including but not limited to the amount, flow (incoming/outgoing) concentration, temperature, and pH to enhance performance.

### Downtime/Breaktime.

During shift changes or breaks, a user may desire that no workpieces 103 are introduced to the system 100. In this regard, in an embodiment, the system 100 is configured to detect idle time (and/or operate on a schedule) and make appropriate adjustments to effect proper treatment of workpieces 103 that is in-process at that time.

In an embodiment, the system 100 is configured to execute a re-start sequence of operations (e.g., increased flow of antimicrobial, decreased flow of antimicrobial) when operations resume following downtime. In an embodiment, the system 100 is configured to effect water reuse during such shifts and break times. In an embodiment, the system 100 includes feedback features (e.g., alarms) to advise the user when a given parameter (e.g., turbidity) is out of specification. In some embodiments, the system executes a re-start sequence of operations autonomously.

### Data Analytics.

In an embodiment, the system 100 includes data analytics software or circuitry that identifies operational settings that give rise to desired or even optimal performance. These settings can be identified based on data collected for a user's specific equipment and product type. A data analytics package can identify the dependent variables and automate the adjustments, such as to implement the identified variables. Such a package can also provide real-time information as well as hold historical data and measurements.

In another aspect, the present disclosure provides a method of operating a system, such as to provide improved antimicrobial application and related data collection.

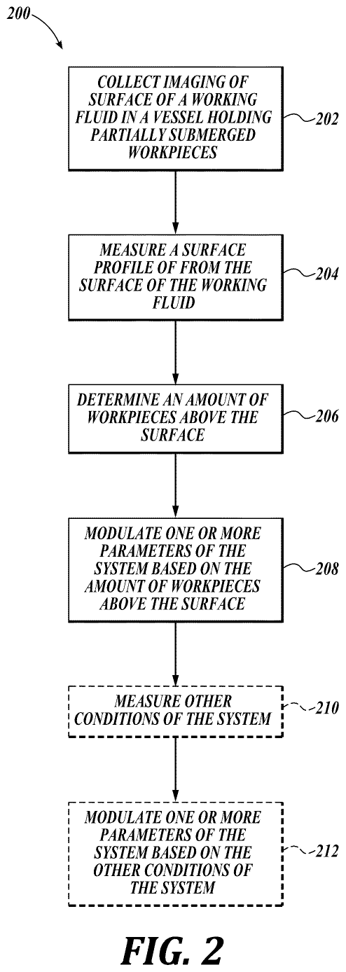

In this regard, attention is directed to FIG. 2 in which a block diagram of a method 200 according to an embodiment of the present disclosure is illustrated. In an embodiment, method 200 is a method for operating a system according to any of the embodiments of the present disclosure, such as the system 100 discussed further herein with respect to FIG. 1. As such, in an embodiment, like terms and element numbers are used to indicate how method 200 can be applied to system 100 for the purpose of clarity. However, it is to be understood that method 200 can be used with any embodiment of the systems claimed and is not thereby limited to the illustrated embodiment of FIG. 1. The order in which some or all of the process blocks appear in process 200 should not be deemed limiting. Rather, one of ordinary skill in the art having the benefit of the present disclosure will understand that some of the process blocks may be executed in a variety of orders not illustrated, or even in parallel.

As also discussed further herein, a workpiece can be, e.g., a whole animal, an animal part, a piece of fruit, a part of a piece of fruit, a vegetable, a piece of a vegetable, and the like. While the present disclosure describes poultry carcasses, and, in certain embodiments, chicken carcasses, it will be understood that the methods of the present disclosure are suitable for and configured to process other workpieces, such as to reduce or eliminate microbial contamination thereon and/or therein.

In an embodiment, method 200 begins with process block 202, which includes collecting imaging data of a surface of a working fluid 128 in a vessel 108 holding at least partially submerged workpieces 103. As discussed further herein, in an embodiment, the working fluid 128 can be carried in a vessel 108, and workpieces 103 can be introduced into the vessel 108 for treatment with the working fluid 128. Some of the workpieces 103 may become exposed, indicating a need to change one or more parameters of the system 100.

In an embodiment, the imaging data collected by surface imaging device 160 at process block 202 includes photographic imaging data and thermal imaging data. For example, in the illustrated embodiments of FIG. 3A-FIG. 4B, a series of images depicting surface imaging data of the surface of the working fluid are depicted in accordance with an embodiment of the present disclosure. In FIG. 3A-FIG. 4B, a system in accordance with system 100 is depicted in a perspective view, taken from the position of an exit of the system, such as exit 122. At the relative far side of the image is a delivery train, such as delivery train 102. The main body of the image depicts a surface of a working fluid in a vessel, such as the surface of working fluid 128 in vessel 108. Throughout the working fluid, a number of workpieces, such as workpiece 103, are visible. On the near side of the image, a gate is depicted for funneling workpieces towards the exit. Additionally, the relative height of the left and right sides of the vessel are substantially different due to the action of an agitator, such as air agitation feature 140.

FIG. 3A provides thermal imaging data from an infrared camera depicting the surface of working fluid 128, and FIG. 3B is a schematic illustration of the same surface of working fluid 128 depicted in FIG. 3A. The thermal imaging data of FIG. 3A depicts the relative temperature of various surface regions of the working fluid 128 in the vessel, the imaging data comprising a relative hot zone 310, as well a region comprising a relative cool zone 320. Relative hot zone 310 has an average temperature that is greater than an average temperature of relative cool zone 320. For instance, relative hot zone 310 may have a temperature of about 120° F., 110° F., 100° F., 90° F., 80° F., 70° F., 60° F., or 50° F., while relative cool zone 320 may have a temperature of about 110° F., 100° F., 90° F., 80° F., 70° F., 60° F., 50° F., or 40° F., provided that the temperature of relative hot zone 310 is greater than the temperature of relative cool zone 320.

Similarly, FIG. 4A is thermal imaging data from an infrared camera depicting the surface of working fluid 128, and FIG. 4B is a schematic illustration of the same surface of working fluid 128 depicted in FIG. 4A. The imaging data of FIG. 4A depicts the relative temperature of various surface regions of the working fluid 128 in the vessel 108, the imaging data comprising a relative warm zone 410, as well a region comprising a relative cool zone 420. Relative warm zone 410 has an average temperature that is greater than an average temperature of relative cool zone 420. For instance, relative warm zone 410 may have a temperature of about 120° F., 110° F., 100° F., 90° F., 80° F., 70° F., 60° F., or 50° F., while relative cool zone 420 may have a temperature of about 110° F., 100° F., 90° F., 80° F., 70° F., 60° F., 50° F., or 40° F., provided that the temperature of relative warm zone 410 is greater than the temperature of relative cool zone 420.

In an embodiment, when workpieces 103 are introduced into the vessel 108, they have a temperature that is higher than a temperature of the working fluid 128. Thus, when workpieces 103 are submerged in the working fluid 128, the thermal imaging data for a region comprising submerged workpieces 103 will appear relatively cool. In contrast, when workpieces 103 are exposed through the surface of the working fluid 128, the imaging data for a region comprising exposed workpieces 103 will appear relatively warm.

As can be seen in comparing FIG. 3B and FIG. 4B, the vessel 108 in FIG. 3B has substantially more workpieces 103 exposed through the surface of the working fluid 128, leading to the relative hot zone depicted in FIG. 3A. Conversely, the vessel 108 in FIG. 4B has workpieces 103 that are substantially submerged throughout the vessel 108, thereby generating thermal imaging data in FIG. 4A that is substantially uniform and cool.

In an embodiment, this thermal imaging data can be compared with the known temperature of the working fluid 128, including but not limited to by generating a thermal imaging threshold which represents the background temperature of the working fluid 128. For instance, if the working fluid 128 has a temperature of about 40° F., the thermal imaging threshold may be set at about 40.1° F., thereby allowing regions of the image corresponding to working fluid 128 to be filtered out of the image In an embodiment, the thermal imaging data can be filtered to identify and exclude regions of the image that correspond to system 100 elements or other environmental features that do not provide information about the surface of working fluid 128.

Turning back to FIG. 2 and process block 202, as described above, the thermal imaging data may include warm zones with exposed workpieces 103 and cool zones with submerged workpieces 103.

For example, in an embodiment, photographic data can be marked by a user to identify a region of interest, and such regions of interest can be correlated to the corresponding pixels on the thermal imaging data, thus generating filtered imaging data. However, it should be understood that any suitable filtering of the imaging data is appropriate and falls within the scope of this disclosure, including positioning the surface imaging device to image a partial segment of the surface of working fluid 128, the use of machine learning to identify regions of interest, including but not limited to based on changes in imaging data over a collection period reflecting variability in surface height, or the like.

Once imaging data is collected, the surface profile of the working fluid 128 can be determined at process block 204. In an embodiment, the surface profile represents a stored matrix of values, including but not limited to thermal values, corresponding to regions of the surface of working fluid 128. Such a matrix of values can be stored and used in digital form, or can be displayed for a user. In an embodiment, the surface profile includes a raw surface profiled and a filtered surface profile, thus providing data of the surface of working fluid 128 as processed in accordance with any of the filtering methods described above. In this way, features of the imaging data that are not related to the number of exposed workpieces 103 can be automatically excluded from the analysis performed by controller 130.

The surface profile, including but not limited to the filtered surface profile, can then be used to determine the amount of workpieces 103 above the surface, as depicted at process block 206. For example, when surface imaging device 160 is a thermal imaging device, a threshold value, such as that based on the temperature of the working fluid 128 as determined by the working fluid temperature sensor 144, can be used to identify regions of the surface profile that do not contain exposed workpieces 103. Other regions can be identified which comprise imaging data consistent with elevated temperatures due to workpieces being exposed through the surface. Other methods of determining the amount of workpieces 103 are possible, though, including but not limited to by using machine learning to track changes in the surface profile over time, and thus identify, from changes in the imaging data such as in the thermal imaging data, an amount of workpieces 103 that are emerging through the surface of working fluid 128. In this way, the system 100 can develop algorithms that are responsive to trends in changes in the characteristics of the surface profile.

With the amount of workpieces 103 exposed through the surface of the working fluid 128 determined, one or more parameters of the system can be modulated, as depicted at process block 206. To achieve superior treatment of workpieces 103, the one or more parameters are configured to alter the relative number and volume of workpieces 103 in the system 100 as compared to the volume of working fluid 128, or to improve mixing of workpieces 103 within the working fluid 128 to improve workpiece 103 coverage.

In an embodiment, process block 204 includes measuring from the imaging data, a surface profile of the surface of the working fluid.

In an embodiment, the surface profile represents a stored matrix of values, including but not limited to thermal values, corresponding to regions of the surface of working fluid. In an embodiment, the surface profile includes a raw surface profile and a filtered surface profile, thus providing data of the surface of working fluid as processed in accordance with any of the filtering methods described above. In this way, features of the imaging data that are not related to the number of exposed workpieces can be automatically excluded from the analysis performed by controller.

In an embodiment, process block 204 is followed by process block 206, which includes determining, from the surface profile, an amount of workpieces above the surface.

For example, when surface imaging device is a thermal imaging device, a threshold value, including but not limited to that based on the temperature of the working fluid as determined by the working fluid temperature sensor, can be used to identify regions of the surface profile that do not contain exposed workpieces. Other regions can be identified which comprise imaging data consistent with elevated temperatures due to workpieces being exposed through the surface. Other methods of determining the amount of workpieces are possible, though, including but not limited to: by using machine learning to track changes in the surface profile over time, and thus identify, from changes in the imaging data such as in the thermal imaging data, an amount of workpieces that are emerging through the surface of working fluid; and by determining a statistical distribution of temperature values in the system 100, and from such a statistical distribution determine if there are any outliers relative to the statistical distribution of temperature values, thereby identifying exposed workpieces 103 as corresponding to outliers relative to the statistical distribution of temperature values.

In an embodiment, process block 206 is followed by process block 208, which includes modulating one or more parameters of the system, such as in system 100, based on the amount of workpieces 103 above the surface.

However, it should be understood that modulating one or more parameters of the system can be based on other measurements of conditions of the system 100, such as in optional process block 210, including but not limited to measurements of the water level in the tank or measurements of the dwell time.

In optional process block 212, the one or more parameters of the system 100 can then be modulated based on the other conditions of the system 100.

While optional process blocks 210 and 212 are illustrated as coming after process block 208, it should be understood that optional process blocks 210 and 212 can occur in any order, including in parallel with other process blocks in process 200.

To achieve superior treatment of workpieces 103, the one or more parameters are configured to alter the relative number and volume of workpieces 103 in the system as compared to the volume of working fluid 128, or to improve mixing of workpieces 103 within the working fluid 128 to improve workpiece 103 coverage.

In an embodiment, modulating the one or more parameters of the system 100 comprises: calculating, from the surface profile, a fraction of exposed workpieces 103; comparing the fraction of exposed workpieces 103 to a reference fraction of exposed workpieces 103; determining, from the difference between the fraction of exposed workpieces 103 and the reference fraction of exposed workpieces 103, an amount of working fluid 128 to add to the vessel 108 through the working fluid input, including but not limited to municipal water port 112, chilled water port 114, and antimicrobial port 116; and transmitting instructions to the at least one working fluid input to increase the volume of working fluid 128 in the vessel 108 by the amount of working fluid 128 to add to the vessel 108.

In an embodiment, the volume of working fluid 128 is modulated by between about 0.05% to about 20%, by between about 0.1% to about 10%, by between about 0.5% to about 10%, by between about 1% to about 10%, by between about 2% to about 9%, by between about 3% to about 8%, by between about 4% to about 7% or by between about 5% to about 6%.

In an embodiment, modulating the one or more parameters of the system 100 comprises: transmitting instructions to a delivery train 102 configured to introduce workpieces 103 into the vessel 108, thereby causing the delivery train 102 to modulate a rate of operation of the delivery train 102. Modulating the rate of operation of the delivery train 102 can include reducing the rate at which the delivery train 102 introduces workpieces 103 into the vessel 108. By reducing the rate at which delivery train 102 introduces workpieces 103 in the vessel 108, a smaller relative number of workpieces 103 can be introduced into the system 100, thus decreasing crowding and resulting in a greater fraction of submerged workpieces 103.

In an embodiment, modulating the one or more parameters of the system 100 comprises: transmitting instructions to a transport train 110 configured to transport workpieces 103 introduced into the vessel 108 towards an exit of the vessel 108, thereby causing the transport train 110 to modulate a rate of operation of the transport train 110. Modulating the rate of operation of the transport train 110 can include increasing the rate at which the transport train 110 transports workpieces 103 towards the exit of the vessel 108. By increasing the rate at which transport train 110 transports workpieces 103 towards the exit of the vessel 108, local inconsistencies in packing volume of the workpieces 103 can be more quickly resolved, including but not limited to by moving a relatively dense region of workpieces 103 into a region that is relatively sparse with respect to workpieces 103.

In an embodiment, modulating the one or more parameters of the system 100 comprises: transmitting instructions to a removal train 118 configured to remove workpieces 103 from the vessel 108 through an exit of the vessel 108, thereby causing the removal train 118 to modulate a rate of operation of the removal train 118. Modulating the rate of operation of the removal train 118 can include increasing the rate at which the removal train 118 removes workpieces 103 from the vessel 108. By increasing the rate at which the removal train 118 removes workpieces 103 from the vessel 108, a larger number of workpieces 103 can be removed relative to the total number of workpieces 103 in the vessel 108, thus resulting in a smaller relative number of workpieces 103 maintained in the system 100. This can decrease crowding and result in a greater fraction of submerged workpieces 103.

In an embodiment, modulating the one or more parameters of the system 100 comprises: transmitting instructions to an agitator, including but not limited to an air agitation feature 140, configured to aerate the working fluid 128, thereby causing the agitator to modulate a level of agitation. Modulating the level of agitation from the agitator can include increasing the level of agitation, thereby decreasing a density of the working fluid 128 relative to a density of the workpieces 103. Modulating the level of agitation from the agitator can also result in increased mixing, thus encouraging floating workpieces 103 to become submerged in working fluid 128.

In an embodiment, modulating the one or more parameters of the system comprises factoring in the number of workpieces 103 in the system 100, including but not limited to is described with respect to first counting sensor 104 and second counting sensor 124, described further herein above. In this manner, the number of workpieces 103 can be factored into determining how modulation of the one or more parameters of the system 100 should proceed. For example, when the number of workpieces 103 is relatively small but the surface profile indicates a large amount of exposed workpieces 103, there may be a large fraction of floating workpieces, which could be resolved by operating the agitator as described herein above. Similarly, if the number of workpieces 103 is relatively large and the surface profile indicates a large amount of exposed workpieces 103, one or more parameters may be adjusted, including but not limited to by decreasing the rate of operation of the delivery train 102 and/or increasing the volume of working fluid 128.

While the above interaction between the data obtained by the surface imaging device and the first counting sensor and second counting sensor is highlighted, it is to be understood that information obtained from the surface imaging device can also be combined with any of the data provided by the sensor train to determine how to modulate the one or more parameters of the system.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

In the detailed description herein, references to “one embodiment”, “an embodiment”, “an example embodiment”, “one or more embodiments, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, approximating language may be applied to modify any quantitative representation that may vary without resulting in a change in the basic function to which it is related. As used herein, the terms “substantially, “about”, and “at or about” mean that the amount or value in question can be the value designated some other value approximately or about the same. It is generally understood, as used herein, that it is the nominal value indicated ±10% variation unless otherwise indicated or inferred. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise. For example, the expression “from about 2 to about 4” also discloses the range “from 2 to 4.”

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The above description of illustrated embodiments of the disclosure, including what is described in the Abstract, is not intended to be exhaustive or to limit the disclosure to the precise forms disclosed. While specific embodiments of, and examples for, the disclosure are described herein for illustrative purposes, various modifications are possible within the scope of the disclosure, as those skilled in the relevant art will recognize.

These modifications can be made to the disclosure in light of the above detailed description. The terms used in the following claims should not be construed to limit the disclosure to the specific embodiments disclosed in the specification. Rather, the scope of the disclosure is to be determined entirely by the following claims, which are to be construed in accordance with established doctrines of claim interpretation.

While illustrative embodiments have been illustrated and described, it will be appreciated that various changes can be made therein without departing from the spirit and scope of the invention.

### Non-Limiting Embodiments

While general features of the disclosure are described and shown and particular features of the disclosure are set forth in the claims, the following non-limiting embodiments relate to features, and combinations of features, that are explicitly envisioned as being part of the disclosure. The following non-limiting embodiments contain elements that are modular and can be combined with each other in any number, order, or combination to form a new non-limiting embodiment, which can itself be further combined with other non-limiting embodiments.

Embodiment 1. A system, comprising: a vessel configured to carry a working fluid and a plurality of workpieces at least partially submerged in the working fluid; an imaging device configured to obtain imaging data from a surface of the working fluid; and a controller operatively coupled to the imaging device, the controller including at least one processor and a computer-readable medium having computer-executable instructions stored thereon that, in response to execution by the at least one processor, cause the controller to perform operations including: collecting, with the imaging device, imaging data that includes the surface of the working fluid; measuring, from the imaging data, a surface profile of the surface of the working fluid; determining, from the surface profile, an amount of workpieces above the surface; and modulating one or more parameters of the system based on the amount of workpieces above the surface.

Embodiment 2. The system of Embodiment 1, wherein the imaging device is an infrared camera.

Embodiment 3. The system of any of Embodiments 1 or 2, wherein the surface profile comprises one or more hot zones and one or more cool zones.

Embodiment 4. The system of any of Embodiments 1-3, wherein modulating the one or more parameters of the system comprises: transmitting instructions to at least one working fluid input configured to flow working fluid into the vessel, thereby causing the at least one working fluid input to modulate a volume of working fluid in the vessel.

Embodiment 5. The system of any of Embodiments 1-4, wherein modulating the one or more parameters of the system comprises: calculating, from the surface profile, a fraction of exposed workpieces; comparing the fraction of exposed workpieces to a reference fraction of exposed workpieces; determining, from a difference between the fraction of exposed workpieces and the reference fraction of exposed workpieces, an amount of working fluid to add to the vessel through the working fluid input; and transmitting instructions to the at least one working fluid input to increase the volume of working fluid in the vessel by the amount of working fluid to add to the vessel.

Embodiment 6. The system of any of Embodiments 1-5, wherein the volume of working fluid is modulated by between about 0.1% to about 10%.

Embodiment 7. The system of any of Embodiments 1-6, wherein modulating the one or more parameters of the system comprises: transmitting instructions to a delivery train configured to introduce workpieces into the vessel, thereby causing the delivery train to modulate a rate of operation of the delivery train.

Embodiment 8. The system of any of Embodiments 1-7, wherein modulating the rate of operation of the delivery train comprises reducing the rate at which the delivery train introduces workpieces into the vessel.

Embodiment 9. The system of any of Embodiments 1-8, wherein modulating the one or more parameters of the system comprises: transmitting instructions to a transport train configured to transport workpieces introduced into the vessel towards an exit of the vessel, thereby causing the transport train to modulate a rate of operation of the transport train.

Embodiment 10. The system of any of Embodiments 1-9, wherein modulating the rate of operation of the transport train comprises increasing the rate at which the transport train transports workpieces towards the exit of the vessel.

Embodiment 11. The system of any of Embodiments 1-10, wherein modulating the one or more parameters of the system comprises: transmitting instructions to a removal train configured to remove workpieces from the vessel through an exit of the vessel, thereby causing the removal train to modulate a rate of operation of the removal train.

Embodiment 12. The system of any of Embodiments 1-11, wherein modulating the rate of operation of the removal train comprises increasing the rate at which the removal train removes workpieces from the vessel.

Embodiment 13. The system of any of Embodiments 1-12, wherein modulating the one or more parameters of the system comprises: transmitting instructions to an agitator configured to aerate the working fluid, thereby causing the agitator to modulate a level of agitation.

Embodiment 14. The system of any of Embodiments 1-13, wherein modulating the level of agitation from the agitator comprises increasing the level of agitation, thereby decreasing a density of the working fluid relative to a density of the workpieces.

Embodiment 15. The system of any of Embodiments 1-14, wherein the system further comprises a counting sensor system configured to estimate a number of workpieces in the vessel, wherein modulating the one or more parameters of the system is further based on the number of workpieces in the vessel.

Embodiment 16. The system of any of Embodiments 1-15, wherein the system further comprises a sensor train configured to monitor one or more conditions of the system and provide a signal based on the one or more conditions.

Embodiment 17. The system of any of Embodiments 1-16, wherein the sensor train comprises a working fluid level sensor configured to measure a level of working fluid and provide a signal based on the level of working fluid, wherein modulating the one or more parameters of the system is further based on the level of working fluid.

Embodiment 18. The system of any of Embodiments 1-17, wherein the sensor train comprises a sensor selected from the group consisting of a pH sensor configured to measure pH of the working fluid, a municipal water flow sensor configured to measure a flow of municipal water through a municipal water port, a chilled water flow sensor configured to measure a chilled water flow through a chilled water port, an antimicrobial flow sensor configured measure a flow of antimicrobial through an antimicrobial port, a rocker sensor configured to provide a status of the transport train, an unloader rate sensor configured to provide a status of the removal train, an antimicrobial reuse sensor configured to determine a level of reuse of the antimicrobial, a working fluid temperature sensor configured to determine a temperature of the working fluid, and an air agitation feature configured to deliver air agitation and also determine a pressure of air agitation delivered to the working fluid and a volume of air agitation delivered to the working fluid, or any combination thereof.

Embodiment 19. The system of any of Embodiments 1-18, wherein the controller further causes the system to perform the operation of filtering out a tank element from the imaging data to generate a filtered imaging data, and wherein a filtered surface profile is measured from the filtered imaging data.

Embodiment 20. A method of operating a system, the method comprising: collecting, with an imaging device, imaging data that includes a surface of a working fluid, wherein the working fluid is carried in a vessel, and wherein a plurality of workpieces are at least partially submerged in the working fluid; measuring, from the imaging data, a surface profile of from the surface of the working fluid; determining, from the surface profile, an amount of workpieces above the surface; and modulating one or more parameters of the system based on the amount of workpieces above the surface.

Embodiment 21. The system of Embodiment 20, wherein modulating the one or more parameters of the system comprises: transmitting instructions to at least one working fluid input configured to flow working fluid into the vessel, thereby causing the at least one working fluid input to modulate a volume of working fluid in the vessel.

Embodiment 22. The system of any of Embodiments 20 or 21, wherein modulating the one or more parameters of the system comprises: calculating, from the surface profile, a fraction of exposed workpieces; comparing the fraction of exposed workpieces to a reference fraction of exposed workpieces; determining, from a difference between the fraction of exposed workpieces and the reference fraction of exposed workpieces, an amount of working fluid to add to the vessel through the working fluid input; and transmitting instructions to the at least one working fluid input to increase the volume of working fluid in the vessel by the amount of working fluid to add to the vessel.

Embodiment 23. The system of any of Embodiments 20-22, wherein modulating the one or more parameters of the system comprises: transmitting instructions to a delivery train configured to introduce workpieces into the vessel, thereby causing the delivery train to modulate a rate of operation of the delivery train.

Embodiment 24. The system of any of Embodiments 20-23, wherein modulating the one or more parameters of the system comprises: transmitting instructions to a transport train configured to transport workpieces introduced into the vessel towards an exit of the vessel, thereby causing the transport train to modulate a rate of operation of the transport train.

Embodiment 25. The system of any of Embodiments 20-24, wherein modulating the one or more parameters of the system comprises: transmitting instructions to a removal train configured to remove workpieces from the vessel through an exit of the vessel, thereby causing the removal train to modulate a rate of operation of the removal train.

Embodiment 26. The system of any of Embodiments 20-25, wherein modulating the one or more parameters of the system comprises: transmitting instructions to an agitator configured to aerate the working fluid, thereby causing the agitator to modulate a level of agitation.

Embodiment 27. The system of any of Embodiments 20-26, wherein the method further comprises filtering out a tank element from the imaging data to generate a filtered imaging data, and wherein a filtered surface profile is measured from the filtered imaging data.

Embodiment 28. The system of any of Embodiments 20-27, wherein the imaging device is an infrared camera

Embodiment 29. The system of any of Embodiments 20-28, wherein the method further comprises: counting, with a counting sensor system, a number of workpieces in the vessel; and further modulating the one or more parameters of the system based on the number of workpieces in the vessel.

Embodiment 30. The system of any of Embodiments 20-29, wherein the method further comprises: sensing, with a sensor train, one or more conditions of the system; providing a signal based on the one or more conditions of the system; and further modulating the one or more parameters of the system based on the signal.

While illustrative embodiments have been illustrated and described, it will be appreciated that various changes can be made therein without departing from the spirit and scope of the disclosure.

1. A system comprising:
a vessel configured to carry a working fluid and a plurality of workpieces at least partially submerged in the working fluid;
an imaging device configured to obtain imaging data from a surface of the working fluid; and
a controller operatively coupled to the imaging device, the controller including at least one processor and a computer-readable medium having computer-executable instructions stored thereon that, in response to execution by the at least one processor, cause the controller to perform operations including:
collecting, with the imaging device, imaging data that includes the surface of the working fluid;
measuring, from the imaging data, a surface profile of the surface of the working fluid;
determining, from the surface profile, an amount of workpieces above the surface; and
modulating one or more parameters of the system based on the amount of workpieces above the surface.

2. The system of claim 1, wherein the imaging device is an infrared camera.

3. The system of claim 2, wherein the surface profile comprises one or more hot zones and one or more cool zones.

4. The system of claim 1, wherein modulating the one or more parameters of the system comprises: transmitting instructions to at least one working fluid input configured to flow working fluid into the vessel, thereby causing the at least one working fluid input to modulate a volume of working fluid in the vessel.

5. The system of claim 4, wherein modulating the one or more parameters of the system comprises:
calculating, from the surface profile, a fraction of exposed workpieces;
comparing the fraction of exposed workpieces to a reference fraction of exposed workpieces;
determining, from a difference between the fraction of exposed workpieces and the reference fraction of exposed workpieces, an amount of working fluid to add to the vessel through the at least one working fluid input; and
transmitting instructions to the at least one working fluid input to increase the volume of working fluid in the vessel by the amount of working fluid to add to the vessel.

6. The system of claim 4, wherein the volume of working fluid is modulated by between about 0.1% to about 10%.

7. The system of claim 1, wherein modulating the one or more parameters of the system comprises: transmitting instructions to a delivery train configured to introduce workpieces into the vessel, thereby causing the delivery train to modulate a rate of operation of the delivery train.

8. (canceled)

9. The system of claim 1, wherein modulating the one or more parameters of the system comprises: transmitting instructions to a transport train configured to transport workpieces introduced into the vessel towards an exit of the vessel, thereby causing the transport train to modulate a rate of operation of the transport train.

10. (canceled)

11. The system of claim 1, wherein modulating the one or more parameters of the system comprises: transmitting instructions to a removal train configured to remove workpieces from the vessel through an exit of the vessel, thereby causing the removal train to modulate a rate of operation of the removal train.

12. (canceled)

13. The system of claim 1, wherein modulating the one or more parameters of the system comprises: transmitting instructions to an agitator configured to aerate the working fluid, thereby causing the agitator to modulate a level of agitation.

14. (canceled)

15. The system of claim 1, further comprising a counting sensor system configured to estimate a number of workpieces in the vessel, wherein modulating the one or more parameters of the system is further based on the number of workpieces in the vessel.

16. The system of claim 1, further comprising a sensor train configured to monitor one or more conditions of the system and provide a signal based on the one or more conditions.

17. (canceled)

18. (canceled)

19. The system of claim 1, wherein the controller further causes the system to perform the operation of filtering out a tank element from the imaging data to generate a filtered imaging data, and wherein a filtered surface profile is measured from the filtered imaging data.

20. A method of operating a system, the method comprising:
collecting, with an imaging device, imaging data that includes a surface of a working fluid, wherein the working fluid is carried in a vessel, and wherein a plurality of workpieces are at least partially submerged in the working fluid;
measuring, from the imaging data, a surface profile of from the surface of the working fluid;
determining, from the surface profile, an amount of workpieces above the surface; and
modulating one or more parameters of the system based on the amount of workpieces above the surface.

21. The method of claim 20, wherein modulating the one or more parameters of the system comprises: transmitting instructions to at least one working fluid input configured to flow working fluid into the vessel, thereby causing the at least one working fluid input to modulate a volume of working fluid in the vessel.

22. The method of claim 21, wherein modulating the one or more parameters of the system comprises:
calculating, from the surface profile, a fraction of exposed workpieces; comparing the fraction of exposed workpieces to a reference fraction of exposed workpieces;
determining, from a difference between the fraction of exposed workpieces and the reference fraction of exposed workpieces, an amount of working fluid to add to the vessel through the working fluid input; and
transmitting instructions to the at least one working fluid input to increase the volume of working fluid in the vessel by the amount of working fluid to add to the vessel.

23. (canceled)

24. (canceled)

25. The method of claim 20, wherein modulating the one or more parameters of the system comprises: transmitting instructions to a removal train configured to remove workpieces from the vessel through an exit of the vessel, thereby causing the removal train to modulate a rate of operation of the removal train.

26. (canceled)

27. The method of claim 20, further comprising filtering out a tank element from the imaging data to generate a filtered imaging data, and wherein a filtered surface profile is measured from the filtered imaging data.

28. The method of claim 20, further comprising:
counting, with a counting sensor system, a number of workpieces in the vessel; and
further modulating the one or more parameters of the system based on the number of workpieces in the vessel.

29. The method of claim 20, further comprising:
sensing, with a sensor train, one or more conditions of the system;
providing a signal based on the one or more conditions of the system; and
further modulating the one or more parameters of the system based on the signal.

30. (canceled)
